(19) United States
(12) Patent Application Publication
(10) Pub. No.: US 2006/0235805 A1
(43) Pub. Date: Oct. 19, 2006

(54) UNIVERSAL ANTI-COUNTERFEIT METHOD AND SYSTEM

(75) Inventors: Feng Peng, Huntington Beach, CA (US); Leo Liyou Li, Trabuco Canyon, CA (US); XUJUN LIANG, East Brunswick, NJ (US)

Correspondence Address: FENG PENG, 6600 WARNER AVE., # 200, HUNTINGTON BEACH, CA, 92647, US

(73) Assignee: Mr. Feng Peng, Huntington Beach, CA (US)

(21) Appl. No.: 10/907,731

(22) Filed: Apr. 13, 2005

(51) Int. Cl. G06F 17/60

(52) U.S. Cl. 705/76

(57) ABSTRACT

A universal system with a unique process is presented to validate the authenticity of a merchandise item using the manufacturer's digital signature embedded in a RFID/smart card tag that is mounted with a merchandise item. This system consists of only the tag reader and the tag and doesn't require complicated mounting methods. New process and methods are devised to allow manufacturers to make and deploy the tags with its own digital signature, and enable buyers not only to validate the authenticity of a merchandise item easily and reliably, but also to check the authenticity of the tag reader itself before the first use.

### BACKGROUND OF THE INVENTION

1. Field of Invention

The present invention generally relates to a system and a process that detect the counterfeited merchandise items. More specifically the present invention describes a practical system with a unique process that is easy to deploy, easy to use, yet very effective and powerful to beat the counterfeiters.

2. Description of the Related Art

Counterfeiting merchandise is a serious problem nowadays, especially with aid of the new sophisticated technologies. The counterfeited products could look more real and be in very large quantity. The counterfeiters rob manufacturers of their brands that may take many years to build, they rob consumers with fake, low quality, sometimes even dangerous products (e.g. medicine). It's generally recognized that a good anti-counterfeit system will be benefiting to both manufacturers and consumers, and it'll be most effective if both manufacturers and consumers participate in the anti-counterfeiting process.

U.S. Pat. No. 6,226,619, entitled “METHOD AND SYSTEM FOR PREVENTING COUNTERFEITING OF HIGH PRICE WHOLESALE AND RETAIL ITEMS” BY Halperin et al. discloses using a RFID tag and a tag reader to empower consumers in an anti-counterfeiting process. The prior method uses a RFID tag attached to an item, a tag reader reads/decrypt the secrete code inside the tag, then a consumer can compare the readout from the reader with a serial number printed on a label on the item to validate the authenticity of the product. However there're several drawbacks in the prior system. First, in addition to the RFID tag and tag readers, unique serial number is required for each item, for large volume items, this makes it hard for manufacturers to implement the system. Secondly, consumers, not the tag reader, are used for the real authentication work, they have to manually and visually compare the readout with a number printed on a label. Considering vast different kinds of merchandise, this is hard for consumers to use and consumers might get confused. Thirdly, the prior method mentions but does not explore the real use of public key encryption that should be the core technology for the authentication system, it fails to provide a solution regarding how vendors distribute public keys to consumers at point of sale. Last but most critical, there is a security hole in the prior system, a counterfeiter equipped with modern technology can easily beat the system by duplicating the entire system, especially the tag reader.

In addition, the prior system is not easy for a vendor to implement. A unique serial number printed on a label for the item is required in the prior method. Creating and maintaining such number system could be a big burden for a vendor, especially when the items are produced in a large quantity and no item level tracking is needed in the existing vendor's system (such as wines). This goes back to the very same problem that the prior method tries to solve—avoid the usage of a large database.

Moreover, the prior system is not easy for consumers to use. In the prior system, consumers have to do a lot of work to authenticate a retail item themselves. They use a tag reader to get the readout, locate the proper label in the item, and then compare the readout with the printed serial number. Since there's no standard formats for labels or serial numbers from different vendors, each time when buy a new product, consumers have to relearn the process. And obviously this manual process is also error prone, since there're chances that a consumer uses wrong label or wrong number.

Although the prior system suggests the usage of public key encryption, it's suggested only for data protection, not for its real use—authentication. In fact, text data (e.g. a vendor name) doesn't have to be encrypted as long as it can be proved that the text is authored by the vendor. Instead of using digital signature technology in tag and tag reader in the prior system, the authentication work is passed to consumers to do manually with extra labels and serial numbers. The prior claim fails to devise a method for vendors to distribute their public keys to consumers at the point of sale to use the prior system. Without this critical step, it is not possible to apply public key encryption to the prior system.

Furthermore, the prior system itself can be easily counterfeited. The previous method relies on the chip manufacturing process itself for non-duplicable data in the tag. Public key encryption is also suggested for the data protection. However a counterfeiter can easily break the system by (1) print a label with a serial number and put it on a fake item, (2) write the same number in clear text into a tag and attach the tag to the fake item, (3) make a simple tag reader to read the clear text in the tag. Obviously, without further protection, a fake anti-counterfeit system could be easily made along with the fake product. With current technologies, making a “fake” prior system seems trivial.

Therefore, the prior system has some serious drawbacks and problems. It is hard for manufacturers to implement, it is not easy for consumers to use it. Although the public key encryption is mentioned, it's only suggested for data protection, not for the real usage—authentication itself. The authentication workload is passed, unfortunately, to consumers. They have to do the authentication work, manually and visually, to compare the readout with some number on some labels. Besides, there's no solution regarding how public keys are distributed to consumers at point of sale. What is more, without another level of protection, the prior system is very vulnerable and can be easily bypassed by fabricating the label, the tag and the reader.

### SUMNARY OF INVETION

In view of the drawbacks and problems of the prior art, an object of the present invention is to provide an anti-counterfeit method, system and process that can be easily applied universally to any product items.

Another object of the present invention is to make the process easy to implement by a vendor and to make the process easy to use by consumers with fully utilizing the power of digital signature for the authentication.

Yet another object of the present invention is to provide an effective method to create public/private key pairs for each vendor and distribute the public keys to the consumers at point of sale in the tag reader, and also uses second level of authentication—tag reader authentication to make the system itself secure and close the security hole. To make the present system completely effective and secure, another type of authentication is needed for the tag reader device itself. Once the reader is proved to be genuine, the authentication functions performed by the reader can be trusted, thus the entire system is secure.

In a first aspect of the present invention, a system and methods are provided with a unique process as basic anti-counterfeiting tools. The system consists of a central authority (CA) website, RFID/smart card tags and RFID/smart card tag readers. The website serves as a central authority (CA) center for vendor registration. A registered vendor will get their vendor-product id along their private key to make their own RFID/smart card tag with the required fields: vendor-product id, company name, product name and some optional fields such as item serial number, and vendor digitally signs the data with the private key. The RFID/smart card tags must be made with the standard security capability to ensure the data integrity and confidentiality.

In a second aspect of the present invention, the CA staff constructs in advance a large batch of public/private key pairs. Each key pair will be uniquely identified by a number that will become the identifier for a product from a company when assigned to a company who registers for a product. A public key repository (key-ring) is constructed using the same batch, but only public keys are stored in the ring. The key-ring is preloaded to the tag reader device and a public key can be uniquely retrieved by a vendor-product id. The reader device is designed in such way that it's possible to update the key-ring with more new public keys.

In a third aspect of the present invention, the specialized tag reader devices can be made by the authorized manufacturers only. The reader has capabilities to read data from a RFID/smart card tag, use the vendor-product id to locate the correct public key from an internal key-ring that is preloaded into the reader device. It then uses the public key to verify the signature of the manufacturer, therefore validate the authenticity of the item in question. The reader device will display the company name and product name on a small LCD window if the signature is validated, otherwise a warning message is displayed. Alternatively, the reader device can be integrated with a PDA or mobile phone device. Instead of using an internal preloaded public key-ring, after getting the vendor-product id from the tag, the reader component can use the wireless connection, such as SMS, WAP, GPRS or other wireless data services, to get the correct public key from the CA's web site.

In a fourth aspect of the present invention, a method is proposed here to validate a tag reader device. A unique serial number is engraved on the cover of each reader device, the same number is also registered in the CA's website database. When first time using the device or whenever not sure, a user can either go to the central authority website or use a telephone service (the URL of the web site and the telephone numbers should be very well publicized and well known), or use the wireless connections (SMS, WAP, GRPS etc.) to connect with the CA service. The user will be first prompted to enter the serial number, then will be asked to press a self-test button on the device which will execute some internal algorithm and display some random-like number in the LCD window. The number along with the serial number then will be used by the website or the telephone/wireless service to validate the reader device.

In summary, with the unique methods and process of the present invention, not only are the drawbacks and problems of the prior art overcome, a truly secure and ease-of-use anti-counterfeit system is created. Once the universal infrastructure and process are in place, vendors and consumers are able to easily and effectively participate in fighting with counterfeiting. Moreover, the present invention also provides a unique solution to protect the tag reader device itself, therefore make the anti-counterfeiting system truly secure and effective. The current invention does not rely on any specific tag mounting/attach method for the items. The tags will be attached or mounted by a product-specific manner. The specific mounting method will determine if the tag should be destroyed once the item is used. Typically the tag is destroyed once a consumable item is used (such as wine, drugs), but will be kept active for other types of items such as bags, cloths.

### BRIEF DESCRIPTION OF THE DRAWINGS

The forgoing and other objects, aspects and advantages will be better understood from following, detailed description of preferred embodiments of the invention with reference to the drawings, in which,

FIG. 1 is an overall process diagram of the first embodiment of the present system.

FIG. 2 is a flow chart to describe the second embodiment of the encryption keys management from the CA staff point of view.

FIG. 3 is a flow chart to illustrate RFID/smart card tag creation process from the vendor point of view.

FIG. 4 is the data format for RFID/smart card tag.

FIG. 5 is a functional diagram of RFID/smart card reader.

FIG. 6 is an alternative functional diagram of RFID/smart card reader with the wireless connection.

FIG. 7 is a process diagram of another embodiment of Tag read device validation process of the present invention.

### DETAILED DISCRIPTION OF PREFERRED EMBODIMENTS OF THE INVENTION

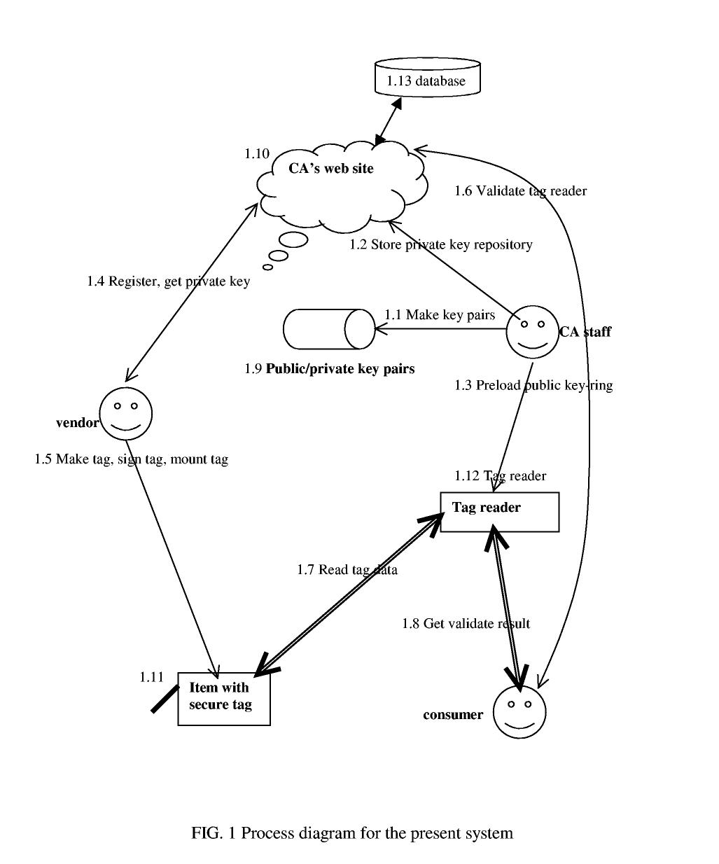

Refer now to the FIG. 1, an overall process diagram for the present system, the system consists of a central authority (CA) website and an internal database, the RFID/smart card tags, RFID/smart card tag readers and a well-defined process. The participants in the process are vendors, consumers and CA's staff (a.k.a. CA), some innovative methods are executed along the steps on the process. The CA website 1.10 has three main functions as a private key repository, as a portal for vendors to register and obtain their own private key and the vendor-product id, and as a portal for consumers to validate the tag readers they use. The CA website 1.10 must be an authorized entity, its URL must be well published and well known. The internal database 1.13 is used to store all the data such as the private key set and the vendor registration information.

The RFID/smart card tag 1.11 is mounted to a merchandise item to be protected. The tag is a standard, commercially available, secured RFID/smart card tag with enough memory to store the vendor data and a digital signature written in a specific format. The tag has the capability to guard the data inside and verify the authenticity of a reader device before granting the data access. The mounting method of the tag is product specific to make the tag either to be destroyed or be kept active after use of the merchandise. The tag reader 1.12 is a special device that has the standard RFID/smart card tag reader functions to read and decode the data from a commercially available secured RFID/smart card tag 1.11. The tag reader 1.12 stores internally a preloaded public key repository (key-ring) and has capability to update the key-ring externally. In addition, the tag reader 1.12 has capability to get the vendor-product ID from the tag data, and use the ID to retrieve the public key for the vendor for the product from the key-ring. Furthermore, the tag reader 1.12 has capability to use the public key to validate the digital signature embedded in the tag data and display the result on a LCD window. Finally, the tag reader 1.12 will display the company name and product name on a small LCD window if the signature is validated, otherwise a warning message is displayed. For self-validation purpose, the device also has capability to generate a unique number once a self-test button pressed, based on its own serial number and some other hidden parameters.

In the process step 1.1 in FIG. 1, the CA's staff manufactures a large batch of public/private key pairs 1.9 using the standard cryptograph methods. Each private key and public key 1.9 are indexed separately, but by using the same number that will become a vendor-product ID when a vendor registers a product. In the process step 1.2 in FIG. 1, the pre-made private key set is stored to the CA's database 1.13. Each private key is indexed by a unique number that is to be assigned to a product as a vendor-product ID later. In the process step 1.3 in FIG. 1, the pre-made public key set is loaded into the tag reader devices as the public key-ring. Each public key is indexed and can be retrieved by a vendor-product ID that can be read from a RFID/smart card tag 1.11. In the process step 1.4 in FIG. 1, a vendor registers one product with the CA's website 1.10 and obtains a unique vendor-product ID and the private key. In the process step 1.5 in FIG. 1, a vendor gets commercially available secure tags, writes the required vendor product information into it including the vendor-product ID, digitally signs the information using the private key and saves the signature into the tag, mounts the tag 1.11 with the product item as needed to make the tag either be destroyed or be kept active. In the process step 1.6 in FIG. 1, whenever have doubt or for the first time use, a consumer can collaborate with the CA website 1.10 or the CA telephony/wireless service to run a self-test and validate the authenticity of the tag reader in use. The details of the technique will be elaborated in the FIG. 5. In the process steps 1.7 and 1.8 in FIG. 1, these two steps are executed at point of sale and comprise the majority of activities in the process. The consumers use the tag reader to read the RFID/smart card tag 1.11 mounted with a product item and validate the authenticity of the item.

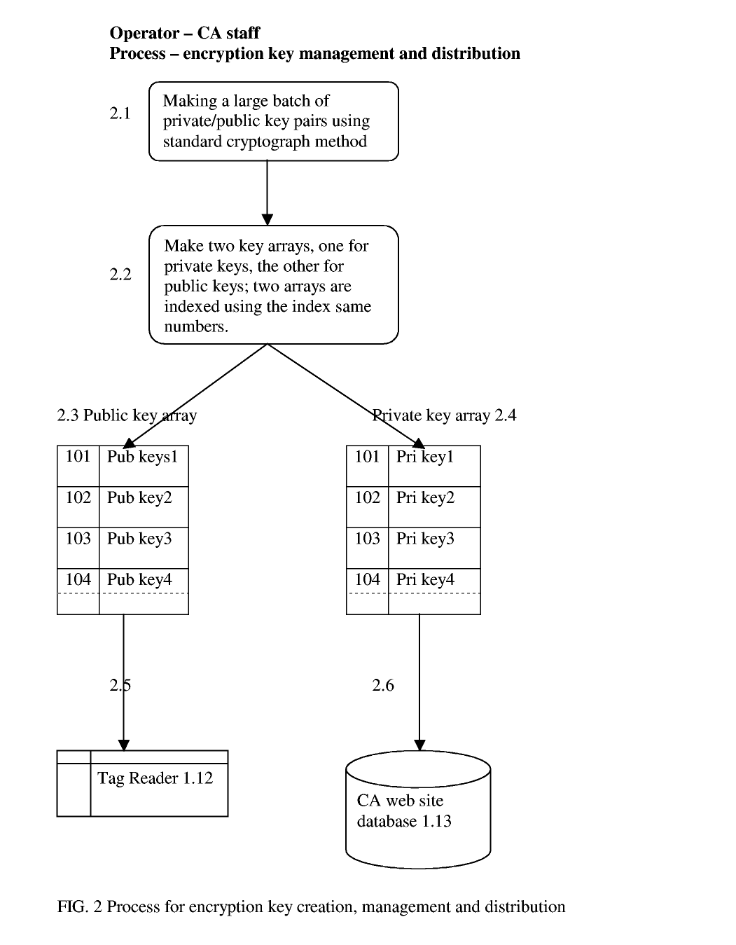

The FIG. 2 describes the encryption key management process in details. First the CA' staff creates a large batch of the public/private key pairs using the standard cryptography method as shown in the step 2.1. Referring to the step 2.2, the key batch is then processed into two separate arrays, one is for the public keys (2.3), the other is for the private keys (2.4). The two key arrays are indexed using the same index numbers. An index number will become a vendor-product Id when assigned to a vendor who registers a product with CA web site (1.10). In step 2.5, the indexed public key array (a.k.a. key-ring) is preloaded into the tag readers. The key-ring is stored in the reader devices in such way that each public key can be uniquely identified and retrieved by an index number, i.e. by a the vendor-product ID. In step 2.6, the indexed private key array (2.4) is stored in the CA web site database (1.13), the private keys and vendor-product Ids will be distributed through the vendor registration process in the CA web site that will be discussed next. In summary, the encryption keys for the present invention are pre-made, indexed by the vendor-product Ids. The public keys (2.3) are preloaded to the tag readers devices (1.11), the private keys (2.4) are stored in CA web site database (1.13). The private keys are distributed to vendors who register with the CA web site (1.10). A registered vendor uses the private key to sign the data stored the RFID/smart card tag, and save the digital signature and the vendor-product Id in the tag also. The public keys are distributed to consumers on the fly in the point of sale when a consumer uses a tag reader to read a vendor-product Id from a RFID/smart card tag, the tag reader in turn uses the vendor-product Id to retrieve the public key and therefore carry on the authentication process.

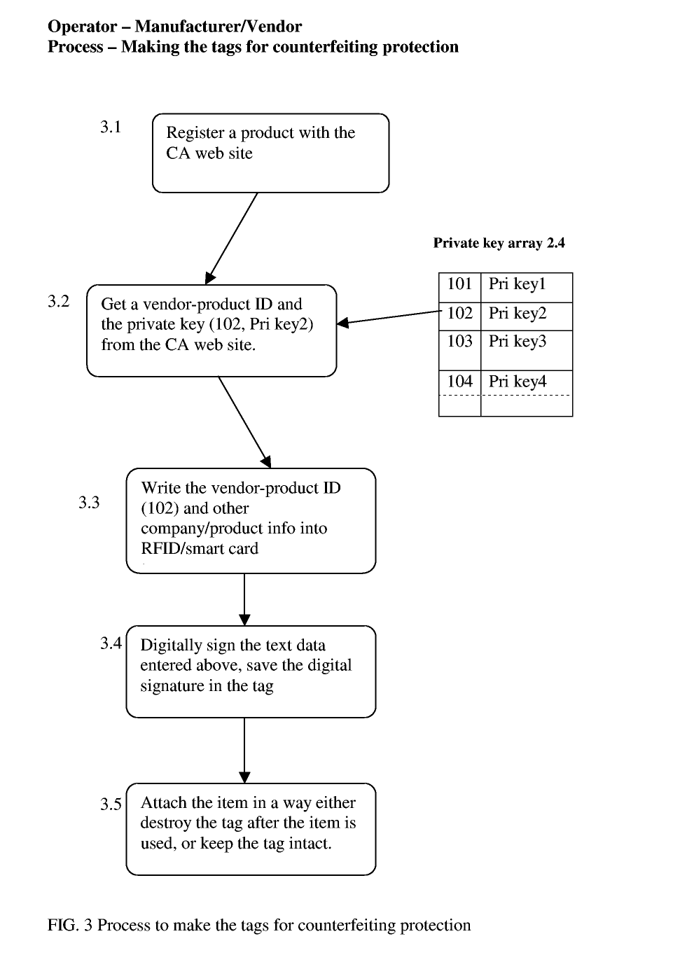

In the FIG. 3, a flowchart explains the entire process for a vendor on how to make their anti-counterfeiting tags. In the first step (3.1), a vendor must registers the product to be protected with the CA website (1.10). After necessary background checking, the vendor is assigned a unique vendor-product Id and private key in step 2 (3.2) from the private key array (2.4) previous stored in CA database (1.13). As an example, the vendor gets vendor-product Id of 102. As discussed in FIG. 2, the corresponding public key is already stored in the tag reader devices (1.12), and can be retrieved by the number 102 (2.3). In step 3 (3.3), the vendor writes the following information to a commercial available RFID/smart card tag, (a) the vendor, product related information, (b) the vendor-product Id (e.g. 102), and (c) the digital signature which is the resulting data from signing the information in (a) in step 3.4. The data format for the tag will be described fully in the next diagram. In the last step 3.5, the vendor attaches the tags to the product items to be protected. Depends on the nature of the product, the mounting method can either destroy the tag after the item has been used, or can keep the tag to be operative after the item has been used.

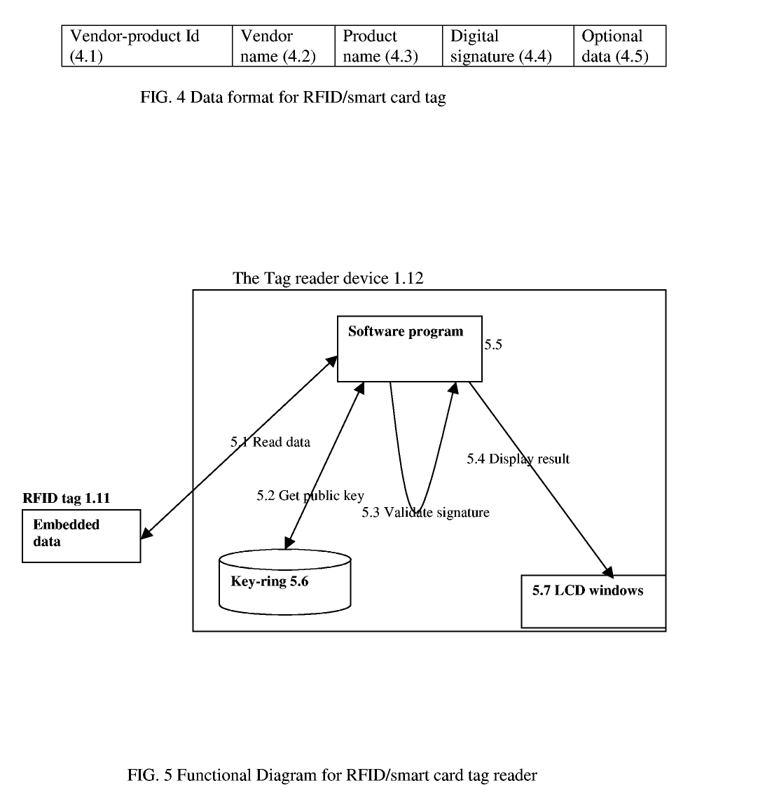

As shown in the FIG. 4, there are four required data fields defined in the tag. Vendor-product id 4.1 is used to retrieve the public key for the product for the vendor from the tag reader device. Vendor-name 4.2 and Product-name 4.3 fields are used to give the user the visual confirmation once the digital signature 4.4 is validated. The optional field 4.5 can store extra vendor/product or item specific information.

The FIG. 5 depicts the main functions a tag reader 1.12 performs. A software program 5.5 serves as a controller of the functions. The tag reader 1.12 first reads the data from a RFID/smart card tag 1.11 in the step 5.1. In the step 5.2, the program parses the input data, obtains the vendor-product id 4.1 from the tag data, and uses it to retrieve the public key for the product from the internal public key-ring 5.6. At step 5.3, the program parses the input data and retrieves the signature, runs the cryptographic algorithm to validate the signature using the public key. In the step 5.4, if the signature is validated, the program retrieves the company name and product name from the input data, displays them in the LCD window 5.7. Otherwise the program just simply displays a warning message in the LCD window 5.7.

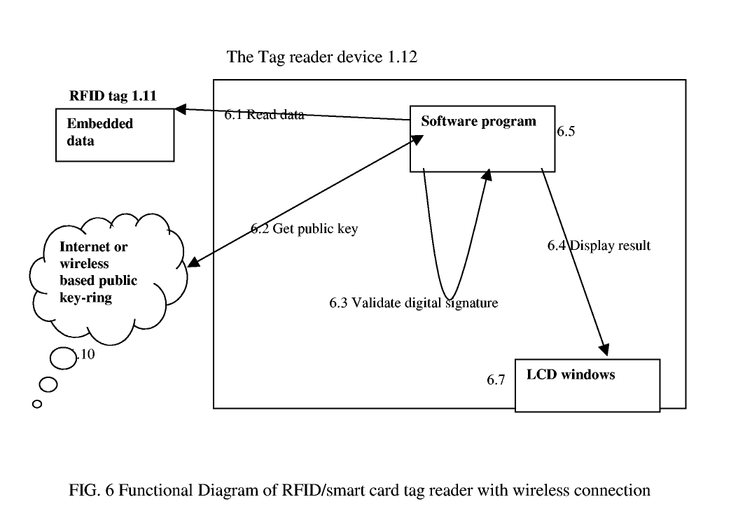

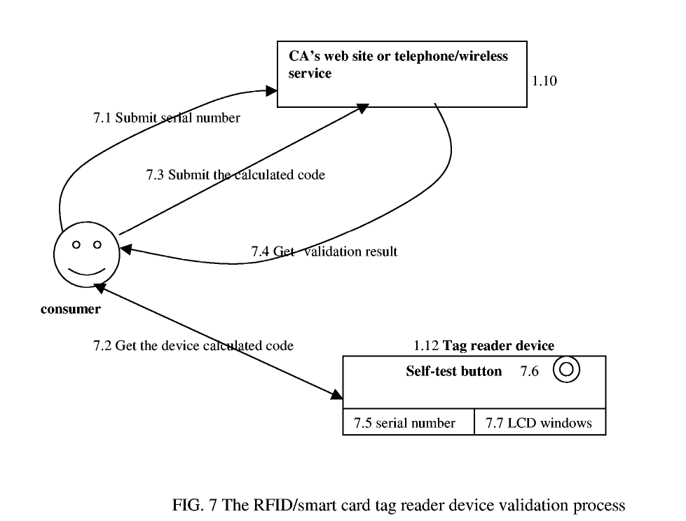

The FIG. 6 illustrates another embodiment of the tag reader 1.12 that is integrated with a PDA or mobile phone device, thus has the wireless connection readily available. With the wireless Internet connection readily available in the point of sale, the public key-ring can be stored in the CA web site 1.10. After getting the Vendor-product id 4.1 in the step 6.1, a software program 6.5 just needs to make a wireless connection and retrieves the public key from the external CA web site 1.10 as shown in step 6.2. A very important aspect of the present invention is to provide a complete solution for the authentication process, including the authentication for the tag reader itself. As pointed out earlier, without another level of validation for the tag reader itself, the entire retail-item level authentication system can be easily rendered useless by a relatively sophisticated counterfeiter equipped with somewhat advanced technology. For example, a counterfeiter could create a complete counterfeit system to deceive consumers by making a fake reader and distributing their own fake tags along with the fake retail items. FIG. 7 describes in detail how the authentication for a tag reader device works. A tag reader device 1.12 is built with a “self-test” button 7.6. A unique serial number 7.5 is also engraved on the cover of the device. The central authority entity (CA) provides both web based or telephony/wireless based interfaces 1.10 for the reader validation. When in doubt, a consumer connects with the CA's tag reader validation service, submits the device serial number 7.5 first at the step 7.1, then run step 7.2 by pressing the “self-test” button 7.6 on the device 1.12. The device responds with a number displayed in the LCD window 7.7. The number is generated uniquely by the internal program using the device serial number and other parameters. At step 7.3, the user submits the generated number to the CA's service 1.10 for the validation. At step 7.4, the CA's service 1.10 runs the same algorithm as the genuine device does to generate a number and compare the two generated numbers for validation. The validation result is sent back to the user. Once the tag reader device is validated and can be trusted, a user can use it repeatedly to perform authentication tasks on all kinds of retail items with the RFID/smart card tags 1.11, the entire authentication system for anti-counterfeiting will be secure and effective.

While this invention has been described in conjunction with the specific embodiments outlined above, it is evident that many alternatives, modifications and variations will be apparent to those skilled in the art. Accordingly, the preferred embodiments of the invention as set forth above are intended to be illustrative not limiting. Various changes may be made without departing from the spirits and scope of the invention as defined in the following claims.

What is claimed is:

1. A method for authenticating an item by using an electronic tag attached to the item, comprising the steps of:
making and indexing a plurality of confidential data comprising at least public/private key pairs;
indexing and storing said private keys in a remote database;
indexing and embedding a plurality of said corresponding public keys for said private keys in a tag reader;
registering and acquiring a vendor-product id and said private key from said remote database through web interface;
digitally signing vendor-related information with said private key to produce a digital signature;
embedding said vendor-related information and said digital signature in said tag;
attaching said tag to the item to be authenticated;
retrieving said vendor-related information and said digital signature from said attached tag by using said tag reader;
acquiring one public key from said a plurality of embedded public keys using retrieved vendor-related information; and
validating said digital signature by using said retrieved public key with said tag reader.

2. The method according to claim 1, wherein said tag is one of RFID or smart card tag.

3. The method according to claim 1, wherein said private keys are indexed and stored in said remote database and assigned to vendors via the said vendor registration process.

4. The method according to claim 1, wherein said public keys are indexed and embedded in said tag reader device and retrieved using a said vendor-product id read from said tag to validate said digital signature.

5. The method according to claim 1, wherein said tag reader can be incorporated into PDA or mobile phone connected to said remote database with one of internet, telephone, or wireless connections including SMS, WAP, and GRPS.

6. The method according to claim 1, wherein further includes a tag reader verifying steps of:
submitting a serial number of said tag reader to a remote database;
generating a code from activating testing function of said tag reader for said submitted serial number;
submits said generated code to said database for validation; and
obtaining the validation result from said database.

7. The method according to claim 1, wherein said tag comprises vendor-product ID, vendor name, product name, said digital signature.

8. The method according to claim 1, wherein said validating step includes displaying either vendor name and product name if said digital signature is validated or a warning message if said digital signature is invalidated.

9. A system for authenticating an item by creating, indexing and distributing private and public keys, comprising the steps of:
means for making and indexing a plurality of confidential data comprising at least public/private key pairs;
means for indexing and storing said private keys in a remote database;
means for indexing and embedding a plurality of said corresponding public keys for said private keys in a tag reader;
means for registering and acquiring a vendor-product id and said private key from said remote database through web interface;
means for digitally signing vendor-related information with said private key to produce a digital signature;
means embedding said vendor-related information and said digital signature in said tag that is attached to the item to be authenticated;
means for retrieving said vendor-related information and said digital signature form said attached tag by using said tag reader;
means for acquiring one public key from said embedded a plurality of public keys using retrieved vendor-related information; and
means for validating said digital signature by using said retrieved public key with said tag reader.

10. The system according to claim 9, wherein said tag is one of RFID or smart card tag.

11. The system according to claim 9, wherein said private keys are indexed and stored in said remote database and assigned to vendors via the said vendor registration process.

12. The system according to claim 9, wherein said public keys are indexed and embedded in said tag reader device and retrieved using a said vendor-product id read from said tag to validate said digital signature.

13. The system according to claim 9, wherein said tag reader can be incorporated into PDA or mobile phone connected to said remote database with one of internet, telephone, or wireless connections including SMS, WAP, and GRPS.

14. The system according to claim 9, wherein further includes a tag reader verifying means for:
submitting a serial number of said tag reader to a remote database;
generating a code from activating testing function of said tag reader for said submitted serial number;
submits said generated code to said database for validation; and
obtaining the validation result from said database.

15. The system according to claim 9, wherein said tag comprises vendor-product ID, vendor name, product name, said digital signature.

16. The system according to claim 9, wherein said means for validating includes display means for displaying either vendor name and product name if said digital signature is validated or a warning message if said digital signature is invalidated.

17. A method of verifying the authentication of a tag reader, comprising:
submitting a unique serial number of said tag reader to a remote database;
generating a unique verifying code from activating testing function of said tag reader for said submitted serial number;
submits said verifying code to said database for validation; and
obtaining the validation result from said database.

18. A method according to claim 17, wherein further includes a step of actuating the test button of said tag reader to start the verifying process and generate said code.

19. A method according to claim 17, wherein further includes a step of activating test function of said remote database to generate a validating code corresponding said submitted serial number.

20. A method according to claim 17, wherein further includes a step of comparing said verifying code and said validating code to verify said tag reader.
